(19) United States
(12) Patent Application Publication
(10) Pub. No.: US 2010/0149482 A1
(43) Pub. Date: Jun. 17, 2010

(54) CONTACT LENS

(76) Inventors: Daniel M. Ammon, JR., Webster, NY (US); Rosa Lee, Rochester, NY (US); Richard I. Blackwell, Webster, NY (US)

Correspondence Address: Bausch & Lomb Incorporated, One Bausch & Lomb Place, Rochester, NY, 14604-2701, US

(21) Appl. No.: 12/333,342

(22) Filed: Dec. 12, 2008

(51) Int. Cl. G02C 7/04

(52) U.S. Cl. 351/160 H; 351/160 R

(57) ABSTRACT

Disclosed are silicone-containing contact lenses having an overall additive thickness less than or equal to about 310 μm.

### BACKGROUND OF THE INVENTION

1. Technical Field

The present invention generally relates to a silicone-containing contact lens such as a silicone hydrogel contact lens.

2. Description of the Related Art

Conventional soft hydrogel contact lenses are often composed of copolymers of hydrophilic monomers such as hydroxyethylmethacrylate, N-vinylpyrrolidone and the like, and can be prepared by lathe-cutting methods, spin casting methods, cast molding methods or combinations thereof, followed by a swelling treatment in a physiological saline and/or phosphate buffer solution to obtain lenses with water contents of about 20 wt. % or about 30 wt. % to about 80 wt. %.

Soft contact lenses made from silicone-containing materials have been investigated for a number of years. An advantage of a silicone-containing contact lens such as silicone hydrogels over conventional hydrogels is the ability of contact lens wearers to wear such silicone hydrogel lenses in their eyes for longer times compared to non-silicone hydrogel contact lenses. The extended time of wearing silicone hydrogel contact lenses is likely related to the high oxygen permeability (Dk) or oxygen transmissibility (Dk/t) of the silicone hydrogel lens materials. The oxygen transmissibility of the lens from the outer surface to the inner surface must be sufficient enough to prevent any substantial corneal swelling during the period of extended wear. Accordingly, there continues to be a need for new silicone-containing contact lenses such as silicone-containing hydrogel contact lenses which have improved oxygen transmissibility that can be made in a simple, cost efficient method. In this manner, the lens can be worn in the eye for an extended period of time without damage to the human cornea from oxygen deprivation.

### SUMMARY OF THE INVENTION

In accordance with one embodiment of the present invention, a silicone-containing contact lens having an overall additive thickness less than or equal to about 310 μm is provided.

In accordance with a second embodiment of the present invention, a silicone-containing contact lens having an overall additive thickness less than or equal to about 270 μm is provided.

In accordance with a third embodiment of the present invention, a silicone-containing contact lens having a nominal center thickness of about 20 μm to about 270 μm, a nominal peripheral thickness of about 20 μm to about 270 μm and a nominal edge thickness of about 20 μm to about 270 μm is provided.

In accordance with a fourth embodiment of the present invention, a silicone-containing contact lens having a nominal center thickness of about 30 μm to about 90 μm, a nominal peripheral thickness of about 100 μm to about 200 μm and a nominal edge thickness of about 30 μm to about 70 μm is provided.

In accordance with a fifth embodiment of the present invention, a hydrated silicone hydrogel contact lens having an overall additive thickness less than or equal to about 310 μm is provided.

The silicone-containing contact lenses of the present invention advantageously possess improved oxygen transmissibility and can be made in a simple, cost efficient method. In this manner, the lenses can be worn in the eye for an extended period of time without damage to the human cornea from oxygen deprivation.

### BRIEF DESCRIPTION OF THE DRAWINGS

FIG. 1 is a cross sectional view of a representative silicone-containing contact lens according to an embodiment of the present invention.

FIG. 2 is a graph illustrating the normalized coefficient of friction of the contact lens of Example 1 in the package of Example 2 versus a commercially available contact lens.

### DESCRIPTION OF THE PREFERRED EMBODIMENTS

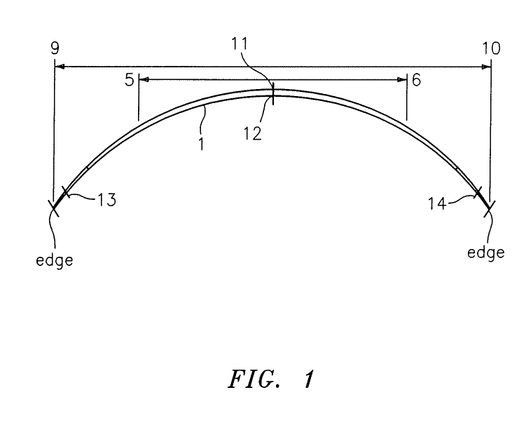

A representative example of a silicone-containing contact lens of the present invention is generally depicted in FIG. 1. The inner surface of the lens is known as the posterior surface. The posterior surface of the lens is generally smooth and of a single radius. The front surface of the lens is known as the anterior surface. The optical zone of the lens is defined between points 5 and 6 of FIG. 1.

The overall diameter or chord of the lens is defined as the distance between points 9 and 10. This diameter is at least about 12 mm, and usually varies between about 13 to about 17 mm and preferably about 14 mm.

The silicone-containing contact lenses of the present invention have an overall additive thickness less than or equal to about 310 μm and preferably less than or equal to about 270 μm. The term “overall additive thickness” as used herein shall be understood to mean the nominal center thickness, nominal peripheral thickness and nominal edge thickness in a hydrated state of the lens when added together provide an overall additive thickness. The term “nominal” as used herein shall be understood to mean a desired thickness in the central region, peripheral region and edge region of the lens being designed such that when these thicknesses are added together the result is an overall additive thickness of the lens being less than or equal to about 310 μm. As one skilled in the art will readily appreciate, the thickness in each of the central region, peripheral region and edge region of the lens of the present invention can vary throughout each region. Accordingly, when determining the overall additive thickness of the lens, the nominal thickness in each region is determined and then these thicknesses are added together to provide the overall additive thickness of the lens.

The silicone-containing contact lenses of the present invention will have a nominal center thickness varying between about 20 to about 270 μm and preferably from about 30 to about 90 μm. The nominal center thickness of the lens is defined between points 11 and 12 of FIG. 1.

The silicone-containing contact lenses of the present invention will have a nominal peripheral thickness about 20 to about 270 μm and preferably from about 100 to about 200 μm. The nominal peripheral thickness of the lens is generally defined as the thickest point outside the optic zone, i.e., from the edge of the lens to point 5 or the edge of the lens to point 6 of FIG. 1.

The silicone-containing contact lenses of the present invention will have a nominal edge thickness of about 20 to about 270 μm and preferably from about 30 to about 70 μm. The nominal edge thickness of the lens is defined as the point between the edge of the lens and point 13 or the edge of the lens to point 14 of FIG. 1. A reduced nominal edge thickness within the limits set forth above is desirable as the edge will have relatively less interference with the eyelid with normal blinking, hence reduced lens lid interaction and enhanced comfort.

The silicone-containing contact lenses of the present invention are overall thinner than those of the prior art, and the reduced overall additive thickness represents a departure from the prior art. The reduced overall additive thickness advantageously permits increased oxygen diffusion through the lens thus avoiding corneal swelling that would otherwise result as a consequence of oxygen deprivation on the corneal surface for an extended period of time. Therefore, the silicone-containing contact lenses of the present invention will have a relatively high oxygen transmissibility (Dk/t), e.g., a Dk/t ranging from about 50 to about 200 barrers/mm and preferably from about 100 to about 150 barrers/mm. The “oxygen transmissibility” of a lens is the rate at which oxygen will pass through a specific ophthalmic lens. Oxygen transmissibility or Dk/t is conventionally expressed in units of barrers/mm, where t is the average thickness of the material [in units of mm] over the area being measured and “barrer” is defined as:
[(cm³ oxygen)(mm)(cm²)(sec)(mm Hg)]×10⁻⁹

The “oxygen permeability”, Dk, of a lens material does not depend on lens thickness. Oxygen permeability is the rate at which oxygen will pass through a material. Oxygen permeability is conventionally expressed in units of barrers, where “barrer” is defined as:
[(cm³ oxygen)(mm)(cm²)(sec)(mm Hg)]×10⁻¹⁰
   These are the units commonly used in the art. Thus, in order to be consistent with the use in the art, the unit “barrer” will have the meanings as defined above. For example, a lens having a Dk of 90 barrers (“oxygen permeability barrer”) and a thickness of 90 microns (0.090 mm) would have a Dk/t of 100 barrers/mm (“oxygen transmissibility barrers”/mm).

The oxygen transmissibility of a lens material may be determined by the following technique. Oxygen fluxes (J) are measured at 34° C. in a wet cell (i.e., gas streams are maintained at about 100% relative humidity) using a Dk 1000 instrument (available from Applied Design and Development Co., Norcross, Ga.), or similar analytical instrument. An air stream, having a known percentage of oxygen (e.g., 21%), is passed across one side of the lens at a rate of about 10 to 20 cm3/min, while a nitrogen stream is passed on the opposite side of the lens at a rate of about 10 to 20 cm³/min. The barometric pressure surrounding the system, P_{measured}, is measured. The thickness (t) of the lens in the area being exposed for testing is determined by measuring about 10 locations with a Mitotoya micrometer VL-50, or similar instrument, and averaging the measurements. The oxygen concentration in the nitrogen stream (i.e., oxygen which diffuses through the lens) is measured using the DK 1000 instrument. The oxygen permeability of the lens material, Dₖ, is determined from the following formula:

Dₖ,=Jₜ(P_{oxygen})

wherein J=oxygen flux [microliters O₂/cm²-minute]
P_{oxygen}=(P_{measured}−P_{water vapor})×(% O₂ in air stream) [mm Hg]=partial pressure of oxygen in the air stream;
P_{measured}=barometric pressure [mm Hg]
P_{water vapor}=0 mm Hg at 34° C. (in a dry cell) [mm Hg]
P_{water vapor}=40 mm Hg at 34° C. (in a wet cell) [mm Hg]t=average thickness of the lens over the exposed test area [mm]
   wherein Dk is expressed in units of barrers, i.e., [(cc oxygen) (mm)/cm²]×[sec/mm Hg]×10 ⁻¹⁰.

The silicone-containing contact lenses of the present invention can be any type of silicone-containing contact lenses such as, for example, soft contact lenses, e.g., a soft, hydrogel lens; soft, non-hydrogel lens, a soft gas permeable lens having less than 5% water and the like, hard contact lenses, e.g., a rigid, gas permeable lens and the like. As is understood by one skilled in the art, a lens is considered to be “soft” if it can be folded back upon itself without breaking.

The silicone-containing contact lenses of the present invention are applicable to a wide variety of materials. In one embodiment, such materials are prepared by polymerizing a mixture containing at least one silicone-containing monomer and at least one hydrophilic monomer. Typically, either the silicone-containing monomer or the hydrophilic monomer functions as a crosslinking agent (a crosslinker being defined as a monomer having multiple polymerizable functionalities) or a separate crosslinker may be employed.

Hydrogels in general are a well-known class of materials that comprise hydrated, cross-linked polymeric systems containing water in an equilibrium state. Silicone hydrogels generally have a water content greater than about 5 weight percent and more commonly between about 10 to about 80 weight percent. Applicable silicone-containing monomeric units for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Representative examples of applicable silicon-containing monomers for use in preparing the silicone-containing contact lenses of the present invention include bulky polysiloxanylalkyl(meth)acrylic monomers represented by the structure of Formula I:

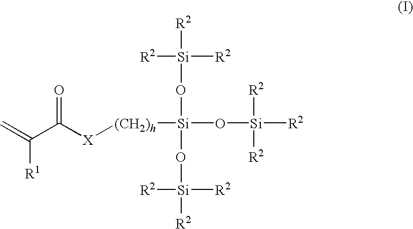

wherein X denotes —O— or —NR—; each R¹ independently denotes hydrogen or methyl; each R² independently denotes a lower alkyl radical, phenyl radical or a group represented by

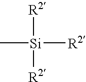

wherein each R^{2′} independently denotes a lower alkyl or phenyl radical; and h is 1 to 10.

Representative examples of other applicable silicon-containing monomers includes, but are not limited to, bulky polysiloxanylalkyl carbamate monomers as generally depicted in Formula Ia:

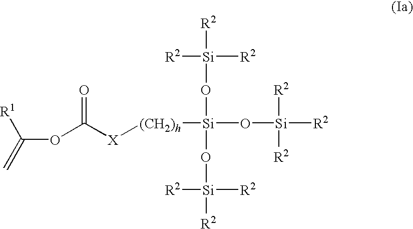

wherein X denotes —NR—; wherein R denotes hydrogen or a C₁-C₄ alkyl; R¹ denotes hydrogen or methyl; each R² independently denotes a lower alkyl radical, phenyl radical or a group represented by

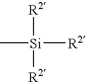

wherein each R^{2′} independently denotes a lower alkyl or phenyl radical; and h is 1 to 10, and the like.

Examples of bulky monomers are 3-methacryloyloxypropyltris(trimethylsiloxy)silane or tris(trimethylsiloxy)silylpropyl methacrylate, sometimes referred to as TRIS, tris(trimethylsiloxy)silylpropyl vinyl carbamate, sometimes referred to as TRIS-VC, 3-[tris(trimethylsiloxy)silyl]propyl allyl carbamate and the like and mixtures thereof.

Such bulky monomers may be copolymerized with a silicone macromonomer, such as a poly(organosiloxane) capped with an unsaturated group at two or more ends of the molecule. U.S. Pat. No. 4,153,641 discloses, for example, various unsaturated groups such as acryloyloxy or methacryloyloxy groups.

Another class of representative silicone-containing monomers includes, but are not limited to, silicone-containing vinyl carbonate monomers such as, for example, 1,3-bis[4-vinyloxycarbonyloxy)but-1-yl]tetramethyl-disiloxane; 3-(trimethylsilyl)propyl vinyl carbonate; 3-(vinyloxycarbonylthio)propyl-[tris(trimethylsiloxy)silane]; 3-[tris(trimethylsiloxy)silyl]propyl vinyl carbonate; t-butyldimethylsiloxyethyl vinyl carbonate; trimethylsilylethyl vinyl carbonate; trimethylsilylmethyl vinyl carbonate and the like and mixtures thereof.

Another class of silicon-containing monomers includes polyurethane-polysiloxane macromonomers (also sometimes referred to as prepolymers), which may have hard-soft-hard blocks like traditional urethane elastomers. They may be end-capped with a hydrophilic monomer such as 2-hydroxyethyl methacrylate (HEMA). Examples of such silicone urethanes are disclosed in a variety or publications, including PCT Published Application No. WO 96/31792 discloses examples of such monomers, which disclosure is hereby incorporated by reference in its entirety. Representative examples of silicone urethane monomers are represented by Formulae II and III:

E(*D*A*D*G)ₐ *D*A*D*E′; or (II)

E(*D*G*D*A)ₐ *D*A*D*E′; or (III)

wherein:

D independently denotes an alkyl diradical, an alkyl cycloalkyl diradical, a cycloalkyl diradical, an aryl diradical or an alkylaryl diradical having 6 to about 30 carbon atoms;

G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;

* denotes a urethane or ureido linkage;

a is at least 1;

A independently denotes a divalent polymeric radical of Formula IV:

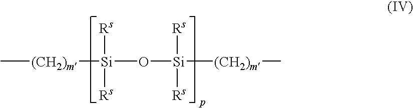

wherein each R^{s} independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;

each of E and E′ independently denotes a polymerizable unsaturated organic radical represented by Formula V:

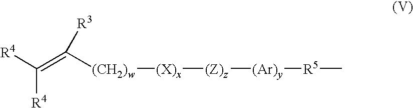

wherein: R³ is hydrogen or methyl;
R⁴ is hydrogen, an alkyl radical having 1 to 6 carbon atoms, or a —CO—Y—R⁶ radical wherein Y is —O—, —S— or —NH—;
R⁵ is a divalent alkylene radical having 1 to about 10 carbon atoms;
R⁶ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

A preferred silicone-containing urethane monomer is represented by Formula VI:

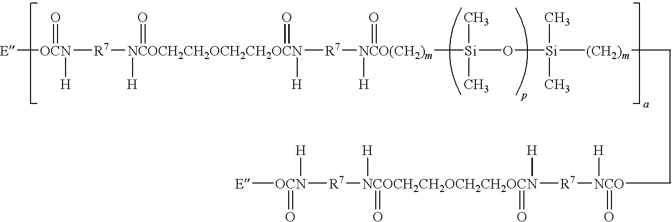

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

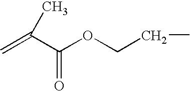

In another embodiment of the present invention, a silicone hydrogel material comprises (in bulk, that is, in the monomer mixture that is copolymerized) about 5 to about 70 percent, and preferably about 10 to about 60, by weight of one or more silicone macromonomers, about 5 to about 60 percent, and preferably about 10 to about 60 percent, by weight of one or more polysiloxanylalkyl (meth)acrylic monomers, and about 20 to about 60 percent, and preferably about 10 to about 50 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 discloses additional unsaturated groups, including acryloyloxy or methacryloyloxy groups. Fumarate-containing materials such as those disclosed in U.S. Pat. Nos. 5,310,779; 5,449,729 and 5,512,205 are also useful substrates in accordance with the invention. Preferably, the silane macromonomer is a silicon-containing vinyl carbonate or vinyl carbamate or a polyurethane-polysiloxane having one or more hard-soft-hard blocks and end-capped with a hydrophilic monomer.

The above materials are merely exemplary, and other materials for use as silicone-containing contact lenses and have been disclosed in various publications and are being continuously developed can also be used. For example, a silicone-containing contact lens for use herein can be formed from at least a cationic material such as a cationic silicone-containing material. In another embodiment, a silicone-containing contact lens for use herein can be formed from at least a fluorinated silicone-containing material. Such material have been used in the formation of, for example, fluorosilicone hydrogels to reduce the accumulation of deposits on contact lenses made therefrom, as disclosed in, for example, U.S. Pat. Nos. 4,954,587; 5,010,141 and 5,079,319. The use of silicone-containing monomers having certain fluorinated side groups, i.e., —(CF₂)—H, can also be used herein, such as those disclosed in, e.g., U.S. Pat. Nos. 5,321,108 and 5,387,662.

Suitable hydrophilic monomers include one or more unsaturated carboxylic acids, vinyl lactams, amides, polymerizable amines, vinyl carbonates, vinyl carbamates, oxazolone monomers, and the like and mixtures thereof. Useful amides include acrylamides such as N,N-dimethylacrylamide and N,N-dimethylmethacrylamide. Useful vinyl lactams include cyclic lactams such as N-vinyl-2-pyrrolidone. Examples of other hydrophilic monomers include poly(alkene glycols) functionalized with polymerizable groups. Examples of useful functionalized poly(alkene glycols) include poly(diethylene glycols) of varying chain length containing monomethacrylate or dimethacrylate end caps. In a preferred embodiment, the poly(alkene glycol) polymer contains at least two alkene glycol monomeric units. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art.

In one embodiment, the silicone-containing contact lenses are prepared by polymerizing a mixture containing at least one of the foregoing silicone-containing monomers and at least one hydrophilic polymer. Suitable hydrophilic polymers include, by way of example, poly(vinylpyrrolidone), polysacharrides, poly(vinylalcohol) and the like and mixtures thereof. The hydrophilic polymers can further contain one or more reactive groups or polymerizable groups such as (meth)acrylate-containing groups, (meth)acrylamide-containing groups, vinylcarbonate-containing groups, vinylcarbamate-containing groups, styrene-containing groups, itaconate-containing groups, vinyl-containing groups, vinyloxy-containing groups, fumarate-containing groups, maleimide-containing groups, vinylsulfonyl groups and the like.

In another embodiment, the silicone-containing contact lenses are prepared by polymerizing a mixture containing at least one of the foregoing silicone-containing monomers and at least one fluoro-containing monomers. Suitable fluoro-containing monomers include, by way of example, fluorine-containing monomers having one or more polymerizable ethylenically unsaturated-containing radicals attached thereto. Representative examples of a “polymerizable ethylenically unsaturated-containing radical” include, by way of example, (meth)acrylate-containing radicals, (meth)acrylamide-containing radicals, vinyl-containing radicals such as vinyl carbonate-containing radicals, vinyl carbamate-containing radicals and the like, styrene-containing radicals, itaconate-containing radicals, vinyloxy-containing radicals, fumarate-containing radicals, maleimide-containing radicals, vinyl sulfonyl radicals and the like. The polymerizable ethylenically unsaturated-containing radicals can be attached to the fluorine-containing monomer as pendent groups, terminal groups or both. In one embodiment, useful polymerizable fluorine-containing monomers include fluorine substituted hydrocarbons having one or more polymerizable ethylenically unsaturated-containing radicals attached thereto and optionally containing one or more ether linkages, e.g., fluorine substituted straight or branched C₁-C₁₈ alkyl groups having one or more polymerizable ethylenically unsaturated-containing radicals attached thereto which may include ether linkages therebetween; fluorine substituted C₃-C₂₄ cycloalkyl groups having one or more polymerizable ethylenically unsaturated-containing radicals attached thereto which may include ether linkages therebetween; fluorine substituted C₅-C₃₀ aryl groups having one or more polymerizable ethylenically unsaturated-containing radicals attached thereto which may include ether linkages therebetween and the like.

Examples of suitable fluorine-containing monomers include, but are not limited to, 2,2,2-trifluoroethyl(meth)acrylate, 2,2,3,3-tetrafluoropropyl(meth)acrylate, 2,2,3,3,3,-pentafluoropropyl(meth)acrylate, 1-trifluoromethyl-2,2,2-trifluoroethyl(meth)acrylate, 1H,1H,5H-octafluoropentyl(meth)acrylate, hexafluoroisopropyl(meth)acrylate, 2,2,3,3,4,4-hexafluorobutyl(meth)acrylate, pentafluorophenyl(meth)acrylate, pentafluorohexyl(meth)acrylate and the like and mixtures thereof.

The monomer mixture used in forming the silicone-containing contact lenses can further include one or more crosslinking agents, strengthening agents, free radical initiators and/or catalysts, dyes, ultraviolet (UV) blockers and the like as is well known in the art.

The silicone-containing contact lenses of the present invention can be prepared by mold polymerization or casting polymerization. Any mold material can be used for mold polymerization or casting polymerization, so long as it is sized and configured to provide the lenses of the present invention having the center, edge and peripheral thicknesses discussed hereinabove. The mold material should also be substantially insoluble to monomer mixture. For example, polyolefin resins such as polypropylene and polyethylene can be used, and materials having polar groups at a surface are preferable. As used herein, a polar group means an atomic group with strong affinity with water and include, by way of example, hydroxyl groups, nitrile groups, carboxyl groups, polyoxyethylene groups, amide groups, urethane groups and the like. Examples of other mold material include polyacrylonitriles, polyesters, polyimides, polyamides, polysulfones, polyvinylidine fluorides, polyvinyl alcohols and copolymers thereof. In one embodiment, the mold material is a resin described in U.S. Pat. No. 3,426,102 and available from British Petroleum under the trademark “Barex”. Generally, a Barex resin is a rubber modified copolymer containing about 75% acrylonitrile and about 25% methyl acrylate. In another embodiment, the mold material is a polyimide such as a polyetherimide or a copolymer thereof. Such resins are commercially available from General Electric under the trademark “Ultem”. In yet another embodiment, the mold material is a polyvinyl alcohol or a copolymer thereof such as an ethylene vinyl alcohol copolymer.

The method of polymerization or cure is not critical to the practice of this invention, except that this invention is particularly suitable to free radical polymerization systems as are well known in the contact lens art. Thus, the polymerization can occur by a variety of mechanisms depending on the specific composition employed. For example, thermal, photo, X-ray, microwave, and combinations thereof which are free radical polymerization techniques can be employed herein. Preferably, thermal and photo polymerizations are used in this invention with UV polymerization being most preferred.

If desired, an organic diluent can be included in the initial monomeric mixture in order to minimize phase separation of polymerized products produced by polymerization of the monomeric mixture and to lower the glass transition temperature of the reacting polymeric mixture, which allows for a more efficient curing process and ultimately results in a more uniformly polymerized product. Sufficient uniformity of the initial monomeric mixture and the polymerized product is of particular importance for silicone hydrogels, primarily due to the inclusion of silicone-containing monomers which may tend to separate from the hydrophilic comonomer.

Suitable organic diluents include, for example, monohydric alcohols such as C₆-C₁₀ straight-chained aliphatic monohydric alcohols, e.g., n-hexanol and n-nonanol; diols such as ethylene glycol; polyols such as glycerin; ethers such as diethylene glycol monoethyl ether; ketones such as methyl ethyl ketone; esters such as methyl enanthate; and hydrocarbons such as toluene. Preferably, the organic diluent is sufficiently volatile to facilitate its removal from a cured article by evaporation at or near ambient pressure. Generally, the diluent may be included at about 5 to about 60 percent by weight of the monomeric mixture, with about 10 to about 50 percent by weight being preferred. If necessary, the cured lens may be subjected to solvent removal, which can be accomplished by evaporation at or near ambient pressure or under vacuum. An elevated temperature can be employed to shorten the time necessary to evaporate the diluent.

The silicone-containing contact lenses of the present invention can be subjected to optional machining operations. The machining step includes, for example, buffing or polishing a lens edge and/or surface. Generally, such machining processes may be performed before or after the article is released from a mold part. As an example, the lens can be dry released from the mold. Alternatively, the lens can be wet released from the mold with an organic solvent, or mixture of solvent and water.

If desired, the surfaces of the silicone-containing contact lenses of the present invention may be modified by, for example, applying plasma treatment, ozone treatment, corona discharge, chemical reaction and/or other treatment, graft polymerization and the like as known in the art. The surfaces of the contact lenses may be modified to increase surface wettability, that is, to increase the wettability of the surface or surfaces of the lens, for example, after molding the lens.

The silicone-containing contact lenses of the present invention may be in any suitable configuration effective to satisfy the needs of the lens wearer. For example, the lenses may have a single refractive power or two or more refractive powers, such as a bifocal or multifocal lens, or may have no refractive power. The lenses can provide spherical corrections, aspherical corrections, cylinder corrections, wave front corrections, corrections of aberrations and the like. The lenses can be configured to be rotationally stabilized, for example, including ballasts, other rotationally stabilizing features and the like. The lenses can be untinted, tinted, colored, e.g., with iris-simulating patterns, and the like.

The silicone-containing contact lenses may then be transferred to individual lens packages containing a buffered saline solution such as, for example, a hydroxylpropyl methyl cellulose containing solution. The saline solution may be added to the package either before or after transfer of the lens. Appropriate packaging designs and materials are known in the art. A plastic package is releasably sealed with a film. Suitable sealing films are known in the art and include foils, polymer films and mixtures thereof. The sealed packages containing the lenses are then sterilized to ensure a sterile product. Suitable sterilization means and conditions are known in the art and include, for example, autoclaving.

The following examples are provided to enable one skilled in the art to practice the invention and are merely illustrative of the invention. The examples should not be read as limiting the scope of the invention as defined in the claims.

### EXAMPLE 1

A contact lens was prepared by casting a monomer mixture containing the components set forth in one of the formulations of the examples in U.S. Pat. No. 5,260,000 in a polypropylene contact lens mold and then UV curing the monomer mixture for about 20 minutes. The resulting contact lens had a water content of approximately 36 wt. %.

The nominal center thickness of the lens was then measured by a Rehder gauge (an electronic thickness gauge available by the Rehder Development Company, Castro Valley, Calif.). The nominal peripheral thickness and nominal edge thickness of the resulting contact lens were measured by a Nikon Eclipse E600 video microscope. The nominal peripheral thickness is defined as the thickest portion of the lens between the optic zone and the edge and the edge is defined as being 0.200 mm in from the tip of the lens. The nominal center thickness, nominal peripheral thickness and nominal edge thickness provided an overall additive thickness of 270 μm.

### EXAMPLE 2

The contact lens of Example 1 was immersed in an aqueous packaging solution containing 0.3 wt. % hydroxypropyl methyl cellulose in a borate buffered saline at a pH of 7.2 in a polypropylene blister package. The package was sealed with foil lidstock and then autoclaved for 30 minutes at 121° C.

Testing

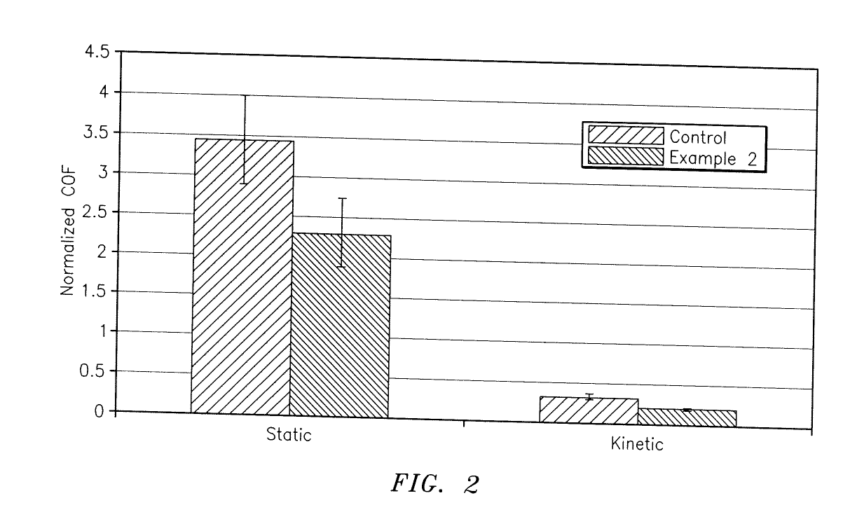

Tribological testing was then performed on the lens of Example 1 in the package of Example 2 and compared to a currently marketed Purevision contact lens (Bausch & Lomb, Inc.) as a control lens using a CETR Model UMT-2 micro-tribometer. First, the sealed polypropylene blister package was unsealed and the contact lens was removed from the solution in the package. The lens was immediately mounted and tested in 1 mL phosphate borate saline (PBS). The lens was clamped on an HDPE holder that initially mates with the posterior side of the lens. A poly(propylene) clamping ring was then used to hold the edge region of the lens. Once the lens was mounted in the holder the assembly was placed in a stationary clamping device within the micro-tribometer. A polished stainless steel disc containing 1 mL of a phosphate buffered saline (PBS) was then brought into contact with the lens and normal force was adjusted to 2 grams over the course of the run for the frictional measurements. After the load equilibrated for 5 seconds the stainless steel disc was rotated at a velocity of 12 cm/sec for a duration of 20 seconds in both the forward and reverse directions and the peak (static) and average (kinetic) COF values were recorded. Each value represents the average of 7 to 8 lenses. All data was normalized to the average values obtained at 2 g force from the lens holder in the absence of a lens tested in PBS. Statistical analyses were carried out using Design-Expert software. Statistical comparisons were made using standardized T-tests. The results from this study for the sample of Example 2 and the control lens are shown in FIG. 2.

Tribology is the study of how two surfaces interact with each other when in relative motion. One aspect of tribology that may be of importance to contact lenses is friction. Friction is a measure of a material's resistance to lateral motion when placed against a specific substrate. The relative friction between two surfaces may be described in terms of a coefficient of friction (COF), which is defined as the ratio of the lateral force (Fₓ) that is required to initiate and then sustain movement to the normal force (F_{N}). Further, there are two friction coefficients that may be considered, the peak (or static) and average (or kinetic). The static COF is a measure of how much Fₓ is needed to initiate relative motion of two surfaces and is typically the larger of the two values. Practically, for contact lenses, the static COF is related to the amount of force needed to start a blink cycle or for the lens to begin moving over the cornea. The kinetic COF is a measure of how much lateral force is needed to sustain movement at a particular velocity averaged over a finite period of time. This value is related to the amount of force required to sustain the blink over the course of the entire cycle and the ease of motion of the lens on the cornea (which may be further related to how much the lens moves on the cornea).

As the data in FIG. 2 show, the contact lens of the present invention having an overall additive thickness of 270 μm provided a substantially lower static and kinetic coefficient of friction as compared to the control lens having an overall additive thickness of 359 μm. Accordingly, the contact lens of the present invention is believed to be able to be worn in the eye for an extended period of time without damage to the human cornea from oxygen deprivation.

### COMPARATIVE EXAMPLES

The overall additive thickness of existing silicone hydrogel contact lenses was determined as discussed above. Lens A is the Purevision contact lens (Bausch & Lomb, Inc.); lens B is the Acuvue Oasys contact lens (Johnson & Johnson), lens C is the O₂ Optix contact lens (Ciba Vision); and lens D is the Biofinity contact lens (CooperVision). The overall additive thickness of silicone hydrogel contact lenses A-D is set forth below Table 1.

TABLE 1

| Lens | Overall Additive Thickness |
|---|---|
| A | 359 μm |
| B | 330 μm |
| C | 340 μm |
| D | 315 μm |

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A silicone-containing contact lens having an overall additive thickness less than or equal to about 310 μm.

2. The silicone-containing contact lens of claim 1, having an overall additive thickness less than or equal to about 270 μm.

3. The silicone-containing contact lens of claim 1, having a nominal center thickness of about 20 to about 270 μm.

4. The silicone-containing contact lens of claim 1, having a nominal peripheral thickness of about 20 to about 270 μm.

5. The silicone-containing contact lens of claim 1, having a nominal edge thickness of about 20 to about 270 μm.

6. The silicone-containing contact lens of claim 1, having a nominal center thickness of about 20 μm to about 270 μm, a nominal peripheral thickness of about 20 μm to about 270 μm and a nominal edge thickness of about 20 μm to about 270 μm.

7. The silicone-containing contact lens of claim 1, having a nominal center thickness of about 30 μm to about 90 μm, a nominal peripheral thickness of about 100 μm to about 200 μm and a nominal edge thickness of about 30 μm to about 70 μm.

8. The silicone-containing contact lens of claim 1, having an oxygen transmissibility of about 50 to about 200 barrers/mm.

9. The silicone-containing contact lens of claim 1, having an oxygen transmissibility of about 100 to about 150 barrers/mm.

10. The silicone-containing contact lens of claim 1, comprising a polymerization product of a monomeric mixture comprising a silicon-containing monomer and a hydrophilic monomer.

11. The silicone-containing contact lens of claim 10, wherein the silicon containing monomer comprises a silicon containing monomer selected from the group consisting of a silicon containing vinyl carbonate, silicon containing vinyl carbamate, polyurethane-polysiloxane having one or more hard-soft-hard blocks and end-capped with a hydrophilic monomer, fumarate containing silicon containing monomer, poly(organosiloxane) capped with an unsaturated group at two or more ends of the molecule, polyurethane-polysiloxane macromonomer and mixtures thereof.

12. The silicone-containing contact lens of claim 10, wherein the hydrophilic monomer is selected from the group consisting of an unsaturated carboxylic acid, vinyl lactam, acrylamide, polymerizable amine, vinyl carbonate, vinyl carbamate, oxazolone monomer and mixtures thereof.

13. The silicone-containing contact lens of claim 10, wherein the hydrophilic monomer is selected from the group consisting of methacrylic and acrylic acids, 2-hydroxyethylmethacrylate, N-vinylpyrrolidone, methacrylamide, N,N-dimethylacrylamide and mixtures thereof.

14. The silicone-containing contact lens of claim 1, comprising a polymerization product of a mixture comprising a silicon containing monomer and a hydrophilic polymer.

15. The silicone-containing contact lens of claim 14, wherein the hydrophilic polymer comprises a reactive group or polymerizable group.

16. The silicone-containing contact lens of claim 1, comprising a polymerization product of a monomeric mixture comprising a silicon-containing monomer and a fluoro-containing monomer.

17. The silicone-containing contact lens of claim 1, which is a silicone hydrogel contact lens.

18. The silicone-containing contact lens of claim 1, which is a rigid gas permeable lens, or a soft gas permeable lens having less than 5% water.

19. The silicone-containing contact lens of claim 1, which is hydrated.

20. The silicone-containing contact lens of claim 1, wherein the surface of the lens is surface-modified.

21. The silicone-containing contact lens of claim 20, wherein the lens comprises a colored portion.
